(19) United States
(12) Patent Application Publication
(10) Pub. No.: US 2019/0392258 A1
(43) Pub. Date: Dec. 26, 2019

(54) METHOD AND APPARATUS FOR GENERATING INFORMATION

(71) Applicant: Beijing Baidu Netcom Science and Technology Co., Ltd., Beijing (CN)

(72) Inventors: Haocheng Liu, Beijing (CN); Jihong Zhang, Beijing (CN); Pengfei Tian, Beijing (CN)

(21) Appl. No.: 16/564,562

(22) Filed: Sep. 9, 2019

(30) Foreign Application Priority Data
Nov. 28, 2018 (CN) 201811438674.4

(51) Int. Cl. G06K 9/62; G06N 20/00

(52) U.S. Cl. CPC G06K 9/6257; G06K 9/6215; G06N 20/00; G06K 9/6232

(57) ABSTRACT

Embodiments of the present disclosure disclose a method and apparatus for generating information. The method for generating information includes: acquiring original data and tag data corresponding to the original data; encoding the original data and the tag data using a plurality of encoding algorithms to obtain a multi-dimensional feature encoding sequence; pre-training a machine learning model using the multi-dimensional feature encoding sequence; and determining a multi-dimensional feature encoding for training the machine learning model corresponding to the original data, based on evaluation data for the pre-trained machine learning model.

### CROSS-REFERENCE TO RELATED APPLICATIONS

This application claims priority to Chinese Application No. 201811438674.4, filed on Nov. 28, 2018 and entitled “Method and Apparatus for Generating Information,” the entire disclosure of which is hereby incorporated by reference.

### TECHNICAL FIELD

The present disclosure relates to the field of computer technology, specifically to the field of computer network technology, and more specifically to a method and apparatus for generating information.

### BACKGROUND

With the constant development of technologies, machine models have been used to predict future behavior of users, development trends of businesses and events in more and more fields. During the process of using the machine models for prediction, it is necessary to collect user features and generate feature encoded data meeting prediction requirements.

The collection of the user features and generation of the feature encoded data is a complex process. Traditional user portraits and knowledge maps are based on unsupervised learning methods of rules and statistics. The generated user feature encoded data tends to be weak in the fit effect of a model in a personalized business scenario, which makes the online effect of the model lower than expected. In addition, the effect of business modeling varies greatly, and over-fitting often occurs.

### SUMMARY

Embodiments of the present disclosure provide a method and apparatus for generating information.

In a first aspect, an embodiment of the present disclosure provides a method for generating information, including: acquiring original data and tag data corresponding to the original data; encoding the original data and the tag data using a plurality of encoding algorithms to obtain a multi-dimensional feature encoding sequence; pre-training a machine learning model using the multi-dimensional feature encoding sequence; and determining a multi-dimensional feature encoding for training the machine learning model corresponding to the original data, based on evaluation data for the pre-trained machine learning model.

In some embodiments, the determining a multi-dimensional feature encoding for training the machine learning model corresponding to the original data, based on evaluation data for the pre-trained machine learning model, includes: performing an importance analysis on the multi-dimensional feature encoding based on a feature required to train the machine learning model; and determining the multi-dimensional feature encoding for training the machine learning model corresponding to the original data, based on the evaluation data for the pre-trained machine learning model and a result of the importance analysis.

In some embodiments, the acquiring tag data corresponding to the original data includes: generating structured data based on the original data; acquiring tag data corresponding to the structured data; and the encoding the original data and the tag data using a plurality of encoding algorithms to obtain a multi-dimensional feature encoding sequence includes: encoding the structured data and the tag data using the plurality of encoding algorithms to obtain the multi-dimensional feature encoding sequence.

In some embodiments, the acquiring tag data corresponding to the original data includes: generating the tag data corresponding to the original data according to a business tag generation rule; and/or annotating manually a tag corresponding to the original data.

In some embodiments, the plurality of encoding algorithms include at least two of the following: a word bag encoding algorithm, a TF-IDF encoding algorithm, a timing encoding algorithm, an evidence weight encoding algorithm, an entropy encoding algorithm, or a gradient lifting tree encoding algorithm.

In some embodiments, the pre-trained machine learning model includes at least one of the following: a logistic regression model, a gradient lifting tree model, a random forest model, or a deep neural network model.

In a second aspect, an embodiment of the present disclosure provides an apparatus for generating information, including: a data acquisition unit, configured to acquire original data and tag data corresponding to the original data; a data encoding unit, configured to encode the original data and the tag data using a plurality of encoding algorithms to obtain a multi-dimensional feature encoding sequence; a model pre-training unit, configured to pre-train a machine learning model using the multi-dimensional feature encoding sequence; and an encoding determining unit, configured to determine a multi-dimensional feature encoding for training the machine learning model corresponding to the original data, based on evaluation data for the pre-trained machine learning model.

In some embodiments, the encoding determining unit includes: an importance analysis subunit, configured to perform an importance analysis on the multi-dimensional feature encoding based on a feature required to train the machine learning model; and an encoding determining subunit, configured to determine the multi-dimensional feature encoding for training the machine learning model corresponding to the original data, based on the evaluation data for the pre-trained machine learning model and a result of the importance analysis.

In some embodiments, the data acquisition unit is further configured to: generate structured data based on the original data; acquire tag data corresponding to the structured data; and the data encoding unit is further configured to: encode the structured data and the tag data using the plurality of encoding algorithms to obtain the multi-dimensional feature encoding sequence.

In some embodiments, the acquiring tag data corresponding to the original data by the data acquisition unit includes: generating the tag data corresponding to the original data according to a business tag generation rule; and/or annotating manually a tag corresponding to the original data.

In some embodiments, the plurality of encoding algorithms used by the data encoding unit include at least two of the following: a word bag encoding algorithm, a TF-IDF encoding algorithm, a timing encoding algorithm, an evidence weight encoding algorithm, an entropy encoding algorithm, or a gradient lifting tree encoding algorithm.

In some embodiments, the pre-trained machine learning model in the model pre-training unit includes at least one of the following: a logistic regression model, a gradient lifting tree model, a random forest model, or a deep neural network model.

In a third aspect, an embodiment of the present disclosure provides a device, including: one or more processors; and a storage apparatus, for storing one or more programs, the one or more programs, when executed by the one or more processors, cause the one or more processors to implement the method according to any one of the above.

In a fourth aspect, an embodiment of the present disclosure provides a computer readable medium, storing a computer program thereon, the program, when executed by a processor, implements the method according to any one of the above.

The method and apparatus for generating information provided by some embodiments of the present disclosure first acquire original data and tag data corresponding to the original data, then encode the original data and the tag data using a plurality of encoding algorithms to obtain a multi-dimensional feature encoding sequence, pre-train a machine learning model using the multi-dimensional feature encoding sequence, and finally determine a multi-dimensional feature encoding for training the machine learning model corresponding to the original data, based on evaluation data for the pre-trained machine learning model. In this process, the determining the multi-dimensional feature encoding for training the machine learning model corresponding to the original data based on the result of the pre-trained machine learning model improves the accuracy and pertinence of the multi-dimensional feature encoding for the original data, thereby improving the efficiency of training the machine learning model.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is a diagram of an example system architecture in which an embodiment of the present disclosure may be implemented;

FIG. 2 is a flowchart showing a method for generating information according to an embodiment of the present disclosure;

FIG. 3 is a schematic diagram of an application scenario of the method for generating information according to an embodiment of the present disclosure;

FIG. 4 is a flowchart showing the method for generating information according to another embodiment of the present disclosure;

FIG. 5 is a schematic structural diagram of an apparatus for generating information according to an embodiment of the present disclosure; and

FIG. 6 is a schematic structural diagram of a computer system adapted to implement a server of some embodiments of the present disclosure.

### DETAILED DESCRIPTION OF EMBODIMENTS

Embodiments of present disclosure will be further described below in detail in combination with the accompanying drawings. It may be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that some embodiments in the present disclosure and some features in the disclosure may be combined with each other on a non-conflict basis. Features of the present disclosure will be described below in detail with reference to the accompanying drawings and in combination with embodiments.

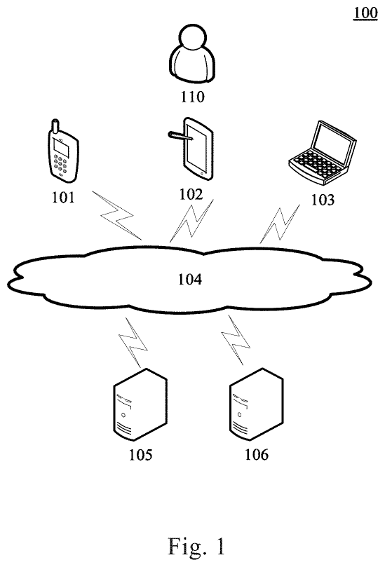

As shown in FIG. 1, a system architecture 100 may include terminal devices 101, 102, 103, a network 104, and servers 105, 106. The network 104 serves as medium providing a communication link between the terminal devices 101, 102, 103 and the servers 105, 106. The network 104 may include various types of connections, such as wired or wireless communication links, or optic fibers.

A user 110 may interact with servers 105, 106 through the network 104 using the terminal devices 101, 102, 103 to receive or send messages or the like. Various communication client applications, such as video capture applications, video playback applications, instant communication tools, mailbox clients, social platform software, search engine applications, or shopping applications, may be installed on the terminal devices 101, 102, and 103.

The terminal devices 101, 102, and 103 may be various electronic devices having display screens, including but not limited to smart phones, tablet computers, e-book readers, MP3 players (Moving Picture Experts Group Audio Layer III), MP4 (Moving Picture Experts Group Audio Layer IV) players, laptop portable computers, desktop computers, etc.

The servers 105, 106 may be servers that provide various services, such as backend servers that provide support for the terminal devices 101, 102, 103. The backend server may perform processing, such as analyzing, storing, or calculating on data submitted by a terminal device, and push the analysis, storage, or calculation result to the terminal device.

It should be noted that, in practice, the method for generating information provided by some embodiments of the present disclosure is generally performed by the servers 105 and 106. Accordingly, the apparatus for generating information is generally provided in the servers 105 and 106. However, when the performance of the terminal device can meet the execution condition of the method or the setting condition of the apparatus, the method for generating information provided by some embodiments of the present disclosure may also be performed by the terminal devices 101, 102, 103, and the apparatus for generating information may also be provided in the terminal devices 101, 102, 103.

It should be understood that the number of terminals, networks, and servers in FIG. 1 is merely illustrative. Depending on the implementation needs, there may be any number of terminals, networks, and servers.

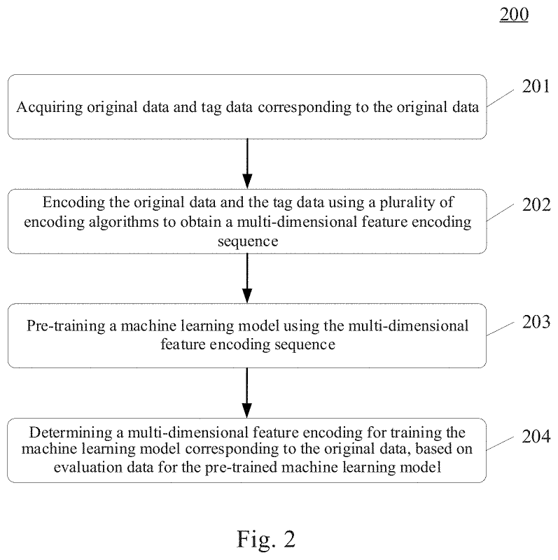

With further reference to FIG. 2, a flow 200 of a method for generating information according to an embodiment of the present disclosure is illustrated. The method for generating information includes the following steps.

Step 201, acquiring original data and tag data corresponding to the original data.

In the present embodiment, an electronic device (for example, the server or terminal shown in FIG. 1) on which the method for generating information is performed may acquire original data from a database or other terminal.

Here, the original data refers to user behavior data based on big data acquisition. For example, user's search log, geographic location, business transaction, and behavior event tracking data. Data event tracking includes three approaches: primary, intermediate and advanced. In the primary approach, statistical codes are embedded in product and service transformation key points, and the independent ID ensures that the data collection is not repeated (such as the purchase button click rate). In the intermediate approach, a plurality of pieces of codes are embedded to track the user's series behavior on each interface of a platform, and the events are independent of each other (such as opening the product details page—selecting the product model—adding to the shopping cart—placing the order—completing the purchase). In the advanced approach, company engineering and ETL collection are combined to analyze user's full-scale behavior, establish user portrait, and restore user behavior model, as the basis for product analysis and optimization.

After the original data is obtained, corresponding tag data may be obtained based on the original data. The tag data corresponding to the original data may be tag data corresponding to the original data generated according to a business tag generation rule. For example, the tag data may be whether the user responds, whether the user is active, or the like. Alternatively or additionally, a tag corresponding to the original data may also be manually annotated. For example, the tag data may be an occupation, an interest, or the like.

Step 202, encoding the original data and the tag data using a plurality of encoding algorithms to obtain a multi-dimensional feature encoding sequence.

In the present embodiment, the plurality of encoding algorithms include at least two of the following: a word bag encoding algorithm, a TF-IDF encoding algorithm, a timing encoding algorithm, an evidence weight encoding algorithm, an entropy encoding algorithm, or a gradient lifting tree encoding algorithm.

When encoding the original data and the tag data using the plurality of encoding algorithms respectively, for each encoding algorithm, a set of multi-dimensional feature encoding may be obtained. Thus, for the plurality of encoding algorithms, a plurality of sets of multi-dimensional feature encoding sequences may be obtained.

Step 203, pre-training a machine learning model using the multi-dimensional feature encoding sequence.

In the present embodiment, for each set of multi-dimensional feature encoding, a machine learning model may be pre-trained to obtain evaluation data for the machine learning model trained using the sets of multi-dimensional feature encoding in subsequent steps. Furthermore, a multi-dimensional feature encoding more suitable for the requirements of the machine learning model may be selected from the sets of multi-dimensional feature encoding.

The machine learning model here may have the capability of identification through sample learning. The machine learning model may use a neural network model, a support vector machine, or a logistic regression model. The neural network model may be, for example, a convolutional neural network, a backpropagation neural network, a feedback neural network, a radial basis neural network, or a self-organizing neural network.

In a specific example, the pre-trained machine learning model may include at least one of: a logistic regression model, a gradient lifting tree model, a random forest model, or a deep neural network model.

Step 204, determining a multi-dimensional feature encoding for training the machine learning model corresponding to the original data, based on evaluation data for the pre-trained machine learning model.

In the present embodiment, after the machine learning model is pre-trained, the pre-trained machine learning model may be evaluated, and based on the evaluation data, a multi-dimensional feature encoding adapted to the machine learning model may be determined, and the multi-dimensional feature encoding is stored. For example, the multi-dimensional feature encoding adapted to the machine learning model is stored to a storage and computing cluster.

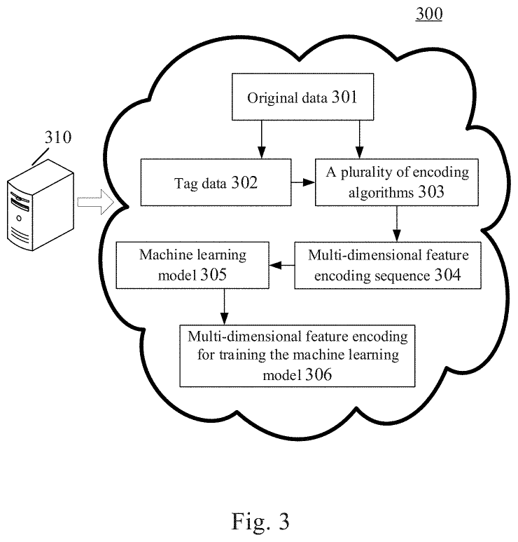

An example application scenario of the method for generating information according to some embodiments of the present disclosure is described below in conjunction with FIG. 3.

As shown in FIG. 3, a schematic flowchart of an application scenario of the method for generating information is illustrated.

As shown in FIG. 3, the method 300 for generating information is performed on an electronic device 310, and may include the following operations.

First, original data 301 and tag data 302 corresponding to the original data 301 are acquired.

Secondly, the original data 301 and the tag data 302 are encoded using a plurality of encoding algorithms 303 to obtain a multi-dimensional feature encoding sequence 304. Here, the plurality of encoding algorithms include a word bag encoding algorithm, a TF-IDF encoding algorithm, a timing encoding algorithm, an evidence weight encoding algorithm, an entropy encoding algorithm, or a gradient lifting tree encoding algorithm.

Thirdly, a machine learning model 305 is pre-trained using the multi-dimensional feature encoding sequence 304.

Finally, based on the evaluation data for the pre-trained machine learning model 305, a multi-dimensional feature encoding 306 for training the machine learning model corresponding to the original data 301 is determined.

It should be understood that the application scenario of the method for generating information shown in FIG. 3 is merely an exemplary description of the method for generating information, and does not represent a limitation to the method. For example, the various steps shown in FIG. 3 may be further implemented in a more detailed method.

The method for generating information provided by some embodiments of the present disclosure first acquires original data and tag data corresponding to the original data, then encodes the original data and the tag data using a plurality of encoding algorithms to obtain a multi-dimensional feature encoding sequence, pre-trains a machine learning model using the multi-dimensional feature encoding sequence, and finally determines a multi-dimensional feature encoding for training the machine learning model corresponding to the original data, based on evaluation data for the pre-trained machine learning model. In this process, the determining the multi-dimensional feature encoding for training the machine learning model corresponding to the original data based on the result of the pre-trained machine learning model, improves the accuracy and pertinence of the multi-dimensional feature encoding for the original data, thereby the efficiency of training the machine learning model may be improved.

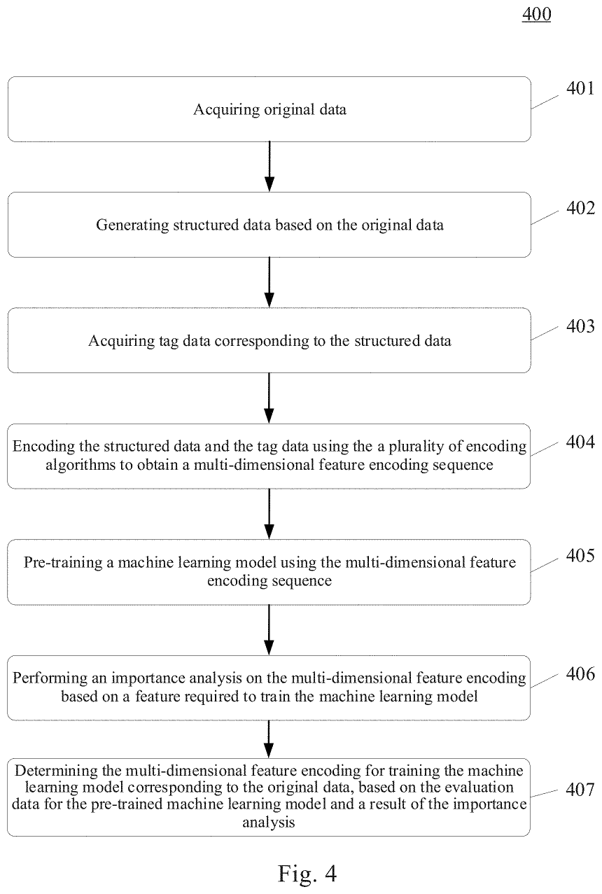

With reference to FIG. 4, a flowchart of the method for generating information according to another embodiment of the present disclosure is illustrated.

As shown in FIG. 4, a flow 400 of the method for generating information of the present embodiment may include the following steps.

In step 401, acquiring original data.

In the present embodiment, an electronic device (for example, the server or terminal shown in FIG. 1) on which the method for generating information is performed may acquire original data from a database or other terminal.

Here, the original data refers to user behavior data based on big data acquisition. For example, user's search log, geographic location, business transaction, and behavior event tracking data. Data event tracking includes three approaches: primary, intermediate and advanced. In the primary approach, statistical codes are embedded in product and service transformation key points, and the independent ID ensures that the data collection is not repeated (such as the purchase button click rate). In the intermediate approach, a plurality of pieces of codes are embedded to track the user's series behavior on each interface of a platform, and the events are independent of each other (such as opening the product details page—selecting the product model—adding to the shopping cart—placing the order—completing the purchase). In the advanced approach, company engineering and ETL collection are combined to analyze user's full-scale behavior, establish user portrait, and restore user behavior model, as the basis for product analysis and optimization.

In a specific example, the acquired original data may include the following:

Search log:

100001, I want to apply for a credit card, https://www.uAB.com,card.cgbXXXXX.com

100002, credit card website, http://www.ABC123.com, http://www.ABD.com

100001, apply for an AB bank credit card, http://www.ABC123.com

100001, how to apply for an AC credit card, http://market.cmbXXXXX.com

100002, how to apply for a credit card, http://www.AB.com, https://www.uAB.com

Geographic location:

100001, Beijing, Beijing

100002, Guangdong, Shenzhen

Business transaction data:

100001,200, overdue

100002,100, not overdue

User behavior event tracking:

100001, check the BA Credit Card Center, check the

AC young card, click on credit card application

100002, check the BA Credit Card Center, check the CC platinum card

In step 402, generating structured data based on the original data.

In the present embodiment, after the original data is acquired, structured data may be generated based on the original data. The structured data refers to data that may be represented and stored using a relational database and represented in two dimensions. The general feature is: data is in units of rows, a row of data represents information of an entity, and the attributes of each row of data are the same. In addition, the structured data may also contain related marks that separate semantic elements and layer records and fields. Therefore, it is also referred to as a self-describing structure. For example, structured data in XML format or JSON format is generated based on the original data.

In a specific example, corresponding to the example of the original data in step 401, the JSON structured data is as follows.

{“100001”:{“query”:[“I want to apply for a credit card”, “Apply for an AC credit card”, “How to apply for an AC credit card”], “url”:[“www.uAB.com”, “www.ABC123.com”, “card.cgbXXXXX.com.cn”, “www.ABC123.com”, “www.ABD.com”, “www.uAB.com”, “www.AB.com”, “market.cmbXXXXX.com”], “event”:[“Check the BA Credit Card Center”, “Check the AC young card”, “Click on credit card application”], “province”: “Beijing”, “city”: “Beijing”, “amount”: 200, “status”: “overdue”}

{“100002”:{“query”:[“Credit card website”, “How to apply for a credit card”], “url”:[“www.ABC123.com”, “www.ABD.com”, “www.uAB.com”, “www.AB.com”], “event”:[“Check the BA Credit Card Center”, “Check the CC platinum card”], “province”: “Guangdong”, “city”: “Shenzhen”, “amount”: 100, “status”: “not overdue”}

In step 403, acquiring tag data corresponding to the structured data.

In the present embodiment, after the structured data is acquired, corresponding tag data may be acquired based on the structured data. The tag data corresponding to the structured data may be generated according to the business tag generation rule. For example, the tag data may be whether the user responds, whether the user is active, or the like. Alternatively or additionally, a tag corresponding to the structured data may also be manually annotated. For example, the tag data may be an occupation, an interest, or the like.

In a specific example, corresponding to the structured data in step 402, the tag corresponding to the structured data in step 402 may be obtained as “predict whether the user applies for an X bank young card.”

In step 404, encoding the structured data and the tag data using a plurality of encoding algorithms to obtain a multi-dimensional feature encoding sequence.

In the present embodiment, the plurality of encoding algorithms include at least two of the following: a word bag encoding algorithm, a TF-IDF encoding algorithm, a timing encoding algorithm, an evidence weight encoding algorithm, an entropy encoding algorithm, or a gradient lifting tree encoding algorithm.

When encoding the structured data and the tag data using the plurality of encoding algorithms respectively, for each encoding algorithm, a set of multi-dimensional feature encoding may be obtained. Thus, for the plurality of encoding algorithms, a plurality of sets of multi-dimensional feature encoding sequences may be obtained.

In a specific example, corresponding to the example of the structured data in the above step 402 and the example of the tag in the step 403, the multi-dimensional feature encoding based on the structured data in the above step 402 and the tag in step 403 using the TF-IDF encoding may be obtained.

After word segmentation, statistics of word frequencies related to finance are obtained, here are “credit card”, “AC”, “application” (“apply for” is synonymous). Statistics of frequencies of url related to finance are obtained, here are www.uAB.com, www.ABC123.com, market.cmbXXXXX.com, card.cgbXXXXX.com. The behavior event tracking makes a feature for each behavior, and the feature takes 1 when the behaviour exists; otherwise, the feature takes 0.

The data is spliced column by column, and the feature encoding is as follows:

$$100001 \; 3 \; 2 \; 3 \; 2 \; 2 \; 1 \; 1 \; 1 \; 1 \; 1 \; 0 \; 1 \; 1 \; 200 \; 1$$

$$100002 \; 2 \; 0 \; 1 \; 1 \; 1 \; 0 \; 0 \; 1 \; 0 \; 0 \; 1 \; 3 \; 4 \; 100 \; 0$$

Tags are extracted from event tracking, for example, predict whether the user applies for an AC young card:

$$100001 \; 1$$

$$100002 \; 0$$

The tags and features are fused according to the user ID to obtain training samples:

$$1 \; 3 \; 2 \; 3 \; 2 \; 2 \; 1 \; 1 \; 1 \; 1 \; 1 \; 0 \; 1 \; 1 \; 200 \; 1$$

$$0 \; 2 \; 0 \; 1 \; 1 \; 1 \; 0 \; 0 \; 1 \; 0 \; 0 \; 1 \; 3 \; 4 \; 100 \; 0$$

In step 405, pre-training a machine learning model using the multi-dimensional feature encoding sequence.

In the present embodiment, the machine learning model may be pre-trained, using the multi-dimensional feature encoding in step 405 as training samples. For each set of multi-dimensional feature encoding, a machine learning model may be pre-trained to obtain evaluation data for the machine learning model trained using the sets of multi-dimensional feature encoding in subsequent steps. Furthermore, multi-dimensional feature encoding more suitable for the requirements of the machine learning model may be selected from the sets of multi-dimensional feature encoding.

The machine learning model here may have the capability of identification through sample learning. The machine learning model may use a neural network model, a support vector machine, or a logistic regression model. The neural network model may be, for example, a convolutional neural network, a backpropagation neural network, a feedback neural network, a radial basis neural network, or a self-organizing neural network.

In a specific example, the pre-trained machine learning model may include at least one of: a logistic regression model, a gradient lifting tree model, a random forest model, or a deep neural network model.

In step 406, performing an importance analysis on the multi-dimensional feature encoding based on a feature required to train the machine learning model.

In the present embodiment, based on the features required to train the machine learning model, the importance of the multi-dimensional feature encoding may be analyzed. In the importance analysis, the similarity between the features required by the machine learning model and the features of the multi-dimensional feature encoding may be analyzed. The multi-dimensional feature encoding with higher similarity may be considered as more important.

In step 407, determining the multi-dimensional feature encoding for training the machine learning model corresponding to the original data, based on the evaluation data for the pre-trained machine learning model and a result of the importance analysis.

In the present embodiment, the machine learning model pre-trained in step 405 may be evaluated to obtain the evaluation data. The multi-dimensional feature encoding applicable to the pre-trained machine learning model is then determined based on the evaluation data and the result of the importance analysis. It should be understood that for different machine learning models, it is necessary in some embodiments of the present disclosure to determine the multi-dimensional feature encoding based on whether the multi-dimensional feature encoding is adapted to the machine learning model. Then, for different machine learning models, the determined multi-dimensional feature encoding may be the same or different.

It should be understood that the application scenario of the method for generating information shown in FIG. 4 is merely an exemplary description of the method for generating information, and does not represent a limitation to the method. For example, after step 405 shown in FIG. 4, the step described in step 204 may also be directly used to determine the multi-dimensional feature encoding for training the machine learning model corresponding to the original data.

The method for generating information of the above embodiment of the present disclosure is different from the embodiment shown in FIG. 2 in that by encoding the structured data and the tag using a plurality of encoding algorithms, the original data may be normalized and a tag is added when encoding, thereby improving the accuracy of the encoding. Further, based on the evaluation data for the pre-trained machine learning model and the result of the importance analysis, the multi-dimensional feature encoding for training the machine learning model corresponding to the original data is determined. In this process, the result of the importance analysis is referenced to improve the accuracy of the finally determined coding.

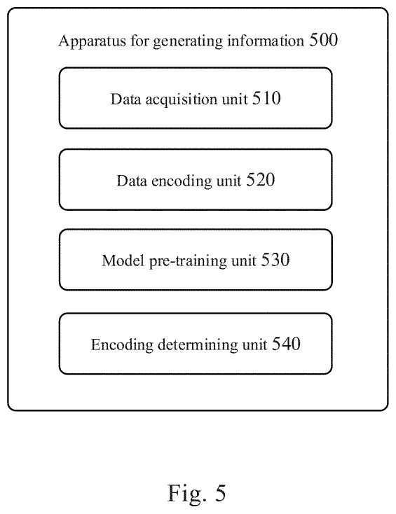

With further reference to FIG. 5, as an implementation of the method shown in the above figures, an embodiment of the present disclosure provides an apparatus for generating information, and the apparatus embodiment may correspond to the method embodiment as shown in FIGS. 2-4, and the apparatus may be specifically applied to various electronic devices.

As shown in FIG. 5, the apparatus 500 for generating information of the present embodiment may include: a data acquisition unit 510, configured to acquire original data and tag data corresponding to the original data; a data encoding unit 520, configured to encode the original data and the tag data using a plurality of encoding algorithms to obtain a multi-dimensional feature encoding sequence; a model pre-training unit 530, configured to pre-train a machine learning model using the multi-dimensional feature encoding sequence; and an encoding determining unit 540, configured to determine a multi-dimensional feature encoding for training the machine learning model corresponding to the original data, based on evaluation data for the pre-trained machine learning model.

In some alternative implementations of the present embodiment, the encoding determining unit 540 includes: an importance analysis subunit (not shown in the figure), configured to perform an importance analysis on the multi-dimensional feature encoding based on a feature required to train the machine learning model; and an encoding determining subunit (not shown in the figure), configured to determine the multi-dimensional feature encoding for training the machine learning model corresponding to the original data, based on the evaluation data for the pre-trained machine learning model and a result of the importance analysis.

In some alternative implementations of the present embodiment, the data acquisition unit 510 is further configured to: generate structured data based on the original data; acquire tag data corresponding to the structured data; and the data encoding unit is further configured to: encode the structured data and the tag data using the plurality of encoding algorithms to obtain the multi-dimensional feature encoding sequence.

In some alternative implementations of the present embodiment, the acquiring tag data corresponding to the original data by the data acquisition unit 510 includes: generating the tag data corresponding to the original data according to a business tag generation rule; and/or annotating manually a tag corresponding to the original data.

In some alternative implementations of the present embodiment, the plurality of encoding algorithms used by the data encoding unit 520 include at least two of the following: a word bag encoding algorithm, a TF-IDF encoding algorithm, a timing encoding algorithm, an evidence weight encoding algorithm, an entropy encoding algorithm, or a gradient lifting tree encoding algorithm.

In some alternative implementations of the present embodiment, the pre-trained machine learning model in the model pre-training unit 530 includes at least one of the following: a logistic regression model, a gradient lifting tree model, a random forest model, or a deep neural network model.

It should be understood that the units recorded in the apparatus 500 may correspond to various steps in the methods described with reference to FIGS. 2-4. Thus, the operations and features described for the method are equally applicable to the apparatus 500 and the units contained therein, and detailed description thereof will be omitted.

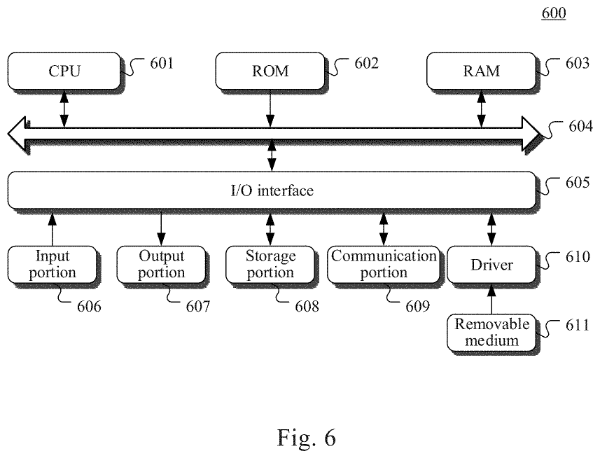

With further reference to FIG. 6, a schematic structural diagram of a computer system 600 adapted to implement a server of some embodiments of the present disclosure is shown. The terminal device or server shown in FIG. 6 is merely an example, and should not impose any limitation on the function and scope of use of some embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, etc.; an output portion 607 including such as a cathode ray tube (CRT), a liquid crystal display device (LCD), a speaker, etc.; a storage portion 608 including a hard disk and the like; and a communication portion 609 including a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to some embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication portion 609, and/or may be installed from the removable medium 611. The computer program, when executed by the central processing unit (CPU) 601, implements the above mentioned functionalities as defined by the methods of some embodiments of the present disclosure. It should be noted that the computer readable medium in some embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In some embodiments of the present disclosure, the computer readable storage medium may be any physical medium containing or storing programs which may be used by a command execution system, apparatus or element or incorporated thereto. In some embodiments of the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in some embodiments of the present disclosure may be implemented by means of software or hardware. The described units may also be provided in a processor, for example, may be described as: a processor including a data acquisition unit, a data encoding unit, a model pre-training unit and an encoding determining unit. Here, the names of these units do not in some cases constitute limitations to such units themselves. For example, the data acquisition unit may also be described as “a unit for acquiring original data and tag data corresponding to the original data.”

In another aspect, some embodiments of the present disclosure further provide a computer readable medium. The computer readable medium may be included in the apparatus in the above described embodiments, or a stand-alone computer readable medium not assembled into the apparatus. The computer readable medium carries one or more programs. The one or more programs, when executed by the apparatus, cause the apparatus to: acquire original data and tag data corresponding to the original data; encode the original data and the tag data using a plurality of encoding algorithms to obtain a multi-dimensional feature encoding sequence; pre-train a machine learning model using the multi-dimensional feature encoding sequence; and determine a multi-dimensional feature encoding for training the machine learning model corresponding to the original data, based on evaluation data for the pre-trained machine learning model.

The above description only provides an explanation of embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for generating information, the method comprising:
acquiring original data and tag data corresponding to the original data;
encoding the original data and the tag data using a plurality of encoding algorithms to obtain a multi-dimensional feature encoding sequence;
pre-training a machine learning model using the multi-dimensional feature encoding sequence; and
determining a multi-dimensional feature encoding for training the machine learning model corresponding to the original data, based on evaluation data for the pre-trained machine learning model.

2. The method according to claim 1, wherein the determining a multi-dimensional feature encoding for training the machine learning model corresponding to the original data, based on evaluation data for the pre-trained machine learning model, comprises:
performing an importance analysis on the multi-dimensional feature encoding based on a feature required to train the machine learning model; and
determining the multi-dimensional feature encoding for training the machine learning model corresponding to the original data, based on the evaluation data for the pre-trained machine learning model and a result of the importance analysis.

3. The method according to claim 1, wherein acquiring the tag data corresponding to the original data comprises:
generating structured data based on the original data; and
acquiring tag data corresponding to the structured data; and
wherein encoding the original data and the tag data using the plurality of encoding algorithms to obtain the multi-dimensional feature encoding sequence comprises:
encoding the structured data and the tag data using the plurality of encoding algorithms to obtain the multi-dimensional feature encoding sequence.

4. The method according to claim 1, wherein acquiring the tag data corresponding to the original data comprises:
generating the tag data corresponding to the original data according to a business tag generation rule; and/or
annotating manually a tag corresponding to the original data.

5. The method according to claim 1, wherein the plurality of encoding algorithms comprise at least two of: a word bag encoding algorithm, a TF-IDF encoding algorithm, a timing encoding algorithm, an evidence weight encoding algorithm, an entropy encoding algorithm, or a gradient lifting tree encoding algorithm.

6. The method according to claim 1, wherein the pre-trained machine learning model comprises at least one of: a logistic regression model, a gradient lifting tree model, a random forest model, or a deep neural network model.

7. An apparatus for generating information, the apparatus comprising:
at least one processor; and
a memory storing instructions, the instructions when executed by the at least one processor, cause the at least one processor to perform operations, the operations comprising:
acquiring original data and tag data corresponding to the original data;
encoding the original data and the tag data using a plurality of encoding algorithms to obtain a multi-dimensional feature encoding sequence;
pre-training a machine learning model using the multi-dimensional feature encoding sequence; and
determining a multi-dimensional feature encoding for training the machine learning model corresponding to the original data, based on evaluation data for the pre-trained machine learning model.

8. The apparatus according to claim 7, wherein the determining a multi-dimensional feature encoding for training the machine learning model corresponding to the original data, based on evaluation data for the pre-trained machine learning model, comprises:
performing an importance analysis on the multi-dimensional feature encoding based on a feature required to train the machine learning model; and
determining the multi-dimensional feature encoding for training the machine learning model corresponding to the original data, based on the evaluation data for the pre-trained machine learning model and a result of the importance analysis.

9. The apparatus according to claim 7, wherein acquiring the tag data corresponding to the original data comprises:
generating structured data based on the original data; and
acquiring tag data corresponding to the structured data, and
wherein encoding the original data and the tag data using the plurality of encoding algorithms to obtain the multi-dimensional feature encoding sequence comprises:
encoding the structured data and the tag data using the plurality of encoding algorithms to obtain the multi-dimensional feature encoding sequence.

10. The apparatus according to claim 7, wherein acquiring the tag data corresponding to the original data comprises:
generating the tag data corresponding to the original data according to a business tag generation rule, and/or
annotating manually a tag corresponding to the original data.

11. The apparatus according to claim 7, wherein the plurality of encoding algorithms comprise at least two of: a word bag encoding algorithm, a TF-IDF encoding algorithm, a timing encoding algorithm, an evidence weight encoding algorithm, an entropy encoding algorithm, or a gradient lifting tree encoding algorithm.

12. The apparatus according to claim 7, wherein the pre-trained machine learning model comprises at least one of: a logistic regression model, a gradient lifting tree model, a random forest model, or a deep neural network model.

13. A non-transitory computer readable medium, storing a computer program thereon, the computer program, when executed by a processor, causes the processor to perform operations, the operations comprising:
acquiring original data and tag data corresponding to the original data;
encoding the original data and the tag data using a plurality of encoding algorithms to obtain a multi-dimensional feature encoding sequence;
pre-training a machine learning model using the multi-dimensional feature encoding sequence; and
determining a multi-dimensional feature encoding for training the machine learning model corresponding to the original data, based on evaluation data for the pre-trained machine learning model.
